(19) United States
(12) Patent Application Publication
(10) Pub. No.: US 2026/0145329 A1
(43) Pub. Date: May 28, 2026

(54) Precise Placement Based on On-the-Fly Object Pose Estimation

(71) Applicant: ABB Schweiz AG, Baden (CH)

(72) Inventors: Yi Chen, Raleigh, NC (US); Jianjun Want, Apex, NC (US); Biao Zhang, Apex, NC (US); Haoyan Liu, Garner, NC (US); Jordi Artigas, Barcelona (ES)

(73) Assignee: ABB Schweiz AG, Baden (CH)

(21) Appl. No.: 19/446,550

(22) Filed: Jan. 12, 2026

Related U.S. Application Data
(63) Continuation of application No. PCT/IB2023/057334, filed on Jul. 18, 2023.

(51) Int. Cl. B25J 9/16

(52) U.S. Cl. CPC B25J 9/1664; B25J 9/1697

(57) ABSTRACT

A method is provided for controlling a robot comprising a plurality of joints. The method comprises moving the robot from a first workspace to a second workspace based on controlling a first joint to rotate the robot along a fixed base, wherein the robot holds an object corresponding to a first tool center point (TCP); obtaining one or more images of the object while the robot is moving, using an image capturing device that moves along with the first joint of the robot; determining a second TCP based on the one or more images; controlling one or more other joints of the robot to adjust the object held by the robot according to the second TCP; and placing the object at a target location of the second workspace according to a refined TCP based on the adjustment result converging to a predetermined reference.

### CROSS-REFERENCE TO RELATED APPLICATIONS

The present application claims priority to International Patent Application No. PCT/IB 2023/057334, filed Jul. 18, 2023, which is incorporated herein in its entirety by reference.

### FIELD

The present disclosure relates to an automatic robotic system.

### BACKGROUND

A robotic device can be and/or include a universal grasping tool and/or an end-effector that can manipulate a variety of objects with different shapes and sizes. This tool (e.g., the universal grasping tool and/or end-effector) can increase the task flexibility of the robot, enabling it to perform a wider range of tasks and adapt to changing environments. However, the use of a universal grasping tool may bring uncertainty about the pose of the object in the gripper after each grasping, which can affect the precision of the placement.

To address this challenge, precise placement of the object in the universal grasping tool usually requires estimating the pose of the object in the gripper after each picking manipulation. However, the cycle time of the precise placement is crucial for the efficiency of productive manufacturing, as it affects the overall production rate. Accordingly, there remains a technical need to enhance robots'ability to execute a maneuver with fewer extra motions or stops between picking and placing.

### SUMMARY

A first aspect of the present disclosure provides a method for controlling a robot comprising a plurality of joints, wherein the plurality of joints comprise a first joint that rotates the entire robot along a fixed base and one or more other joints. The method comprises: moving the robot from a first workspace to a second workspace based on controlling the first joint to rotate the robot along the fixed base, wherein the robot holds an object and the object corresponds to a first tool center point (TCP); obtaining, using an image capturing device, one or more images of the object while the robot is moving from the first workspace to the second workspace, wherein the image capturing device is mounted onto a link connected to the first joint and moves along with the first joint of the robot; determining a second TCP based on the one or more images; controlling the one or more other joints of the robot to adjust the object held by the robot according to the second TCP; and placing the object at a target location of the second workspace according to a refined TCP based on the adjustment result converging to a predetermined reference.

According to an implementation of the first aspect, the method further comprises: determining that the adjustment result does not converge to the predetermined reference; obtaining, using the imaging device, one or more other images of the object while the robot is moving from the first workspace to the second workspace; determining a third TCP based on the one or more other images; controlling the one or more other joints of the robot to adjust the object held by the robot according to the third TCP; and placing the object at the target location of the second workspace according to a refined TCP after the new adjustment result converging to the predetermined reference.

According to an implementation of the first aspect, placing the object at the target location of the second workspace according to the refined TCP based on the adjustment result converging to the predetermined reference further comprises: determining that the adjustment result converges to the predetermined reference; determining a third TCP of the object based on the second TCP and the adjustment to the object; obtaining, using the image capturing device, one or more images of the object after the adjustment; and generating the refined TCP of the object based on the third TCP and the one or more images captured after the adjustment.

According to an implementation of the first aspect, the method further comprises: processing the one or more images to obtain a viewpoint image; and performing a pose estimation based on the viewpoint image, wherein determining the second TCP based on the one or more images is based on the pose estimation.

According to an implementation of the first aspect, processing the one or more images to obtain the viewpoint image further comprises: cropping the one or more images based on the object captured in the one or more images; and removing background in the cropped one or more images based on the one or more images acquired by the imaging device.

According to an implementation of the first aspect, obtaining, using the image capturing device, one or more images of the object while the robot is moving from the first workspace to the second workspace further comprises: controlling motion of the one or more other joints of the robot to allow the image capturing device to capture images of the object from different viewpoints.

According to an implementation of the first aspect, the first TCP is associated with a relative coordinate system established based on a field of view of the image capturing device.

According to an implementation of the first aspect, the adjustment result comprises an updated TCP of the object. The predetermined reference comprises a target TCP of the object, wherein the target TCP of the object corresponds to a predetermined point on the object and is defined by coordinates in the relative coordinate system corresponding to the image capturing device. The adjustment result converging to the predetermined reference is based on the updated TCP of the object converging to the target TCP of the object.

According to an implementation of the first aspect, the adjustment result comprises an updated pose of the object, the predetermined reference comprises a desired pose of the object, and the adjustment result converging to the predetermined reference is based on the updated pose of the object converging to the desired pose of the object.

According to an implementation of the first aspect, the convergence between the updated pose of the object and the desired pose of the object is determined based on an image containing the updated pose of the object and an image containing the desired pose of the object.

According to an implementation of the first aspect, determining the second TCP based on the one or more images further comprises: determining a pose of the object in the relative coordinate system based on the one or more images; determining an offset between the first TCP and the pose of the object in the relative coordinate system; and determining the second TCP based on the first TCP and the offset.

According to an implementation of the first aspect, determining the second TCP based on the one or more images further comprises: determining a pose of the object in the relative coordinate system based on the one or more images; obtaining one or more parameters of the object associated with a position and orientation of the object in the relative coordinate system; and determining the second TCP based on the one or more parameters of the object.

According to an implementation of the first aspect, the one or more images obtained by the image capturing device record motion of the object caused by the one or more other joints, the recorded motion of the object is independent of the motion of the first joint.

According to an implementation of the first aspect, (i) operation of the first joint and (ii) operation of the image capturing device and the one or more other joints are controlled in parallel.

A second aspect of the present disclosure provides a robotic system comprising: a robot comprising a plurality of joints, wherein the plurality of joints comprise a first joint that rotates the entire robot along a fixed base and one or more other joints; an image capturing device mounted onto a link connected to the first joint, wherein the image capturing device is configured to move along with the first joint of the robot and obtain one or more images of an object held by the robot; and a control system. The control system is configured to: move the robot from a first workspace to a second workspace based on controlling the first joint to rotate the robot along the fixed base, wherein the robot holds the object and the object corresponds to a first tool center point (TCP); obtain, using the image capturing device, one or more images of the object while the robot is moving from the first workspace to the second workspace; determine a second TCP based on the one or more images; control the one or more other joints of the robot to adjust the object held by the robot according to the second TCP; and control the robot to place the object at a target location of the second workspace according to a refined TCP based on the adjustment result converging to a predetermined reference.

According to an implementation of the second aspect, the control system is further configured to: determine that the adjustment result does not converge to the predetermined reference; obtain, using the imaging device, one or more other images of the object while the robot is moving from the first workspace to the second workspace; determine a third TCP based on the one or more other images; control the one or more other joints of the robot to adjust the object held by the robot according to the third TCP; and control the robot to place the object at the target location of the second workspace according to a refined TCP after the new adjustment result converging to the predetermined reference.

According to an implementation of the second aspect, the control system is further configured to: determine that the adjustment result converges to the predetermined reference; determine a third TCP of the object based on the second TCP and the adjustment to the object; obtain, using the image capturing device, one or more images of the object after the adjustment; and generate the refined TCP of the object based on the third TCP and the one or more images captured after the adjustment.

According to an implementation of the second aspect, the control system is further configured to: process the one or more images to obtain a viewpoint image; and perform a pose estimation based on the viewpoint image; wherein the control system is configured to determine the second TCP based on the pose estimation.

According to an implementation of the second aspect, the one or more images obtained by the image capturing device record motion of the object caused by the one or more other joints, the recorded motion of the object is independent of the motion of the first joint.

According to an implementation of the second aspect, the control device is further configured to control (i) operation of the first joint and (ii) operation of the image capturing device and the one or more other joints in parallel.

### BRIEF DESCRIPTION OF THE DRAWINGS

Embodiments of the present disclosure will be described in even greater detail below based on the exemplary figures. The present disclosure is not limited to the exemplary embodiments. All features described and/or illustrated herein can be used alone or combined in different combinations in embodiments of the present disclosure. The features and advantages of various embodiments of the present disclosure will become apparent by reading the following detailed description with reference to the attached drawings which illustrate the following:

FIG. 1 illustrates a simplified block diagram depicting a robotic system according to one or more examples of the present disclosure;

FIG. 2 is a schematic illustration of an exemplary control system according to one or more examples of the present disclosure;

FIG. 3A demonstrates an exemplary robotic arm according to one or more embodiments of the present disclosure;

FIG. 3B shows an example of a robotic system operating in a working environment according to one or more embodiments of the present disclosure;

FIG. 4 illustrates a process 400 for operating a robotic system according to one or more embodiments of the present disclosure;

FIG. 5 is a flowchart demonstrating an example process for operating a robotic system according to one or more embodiments of the present disclosure.

### DETAILED DESCRIPTION

The present disclosure describes system integration strategies and algorithms that allow a robotic system to estimate the pose of a manipulated object during motion and make adjustments accordingly to achieve precise object placement and improve efficiency.

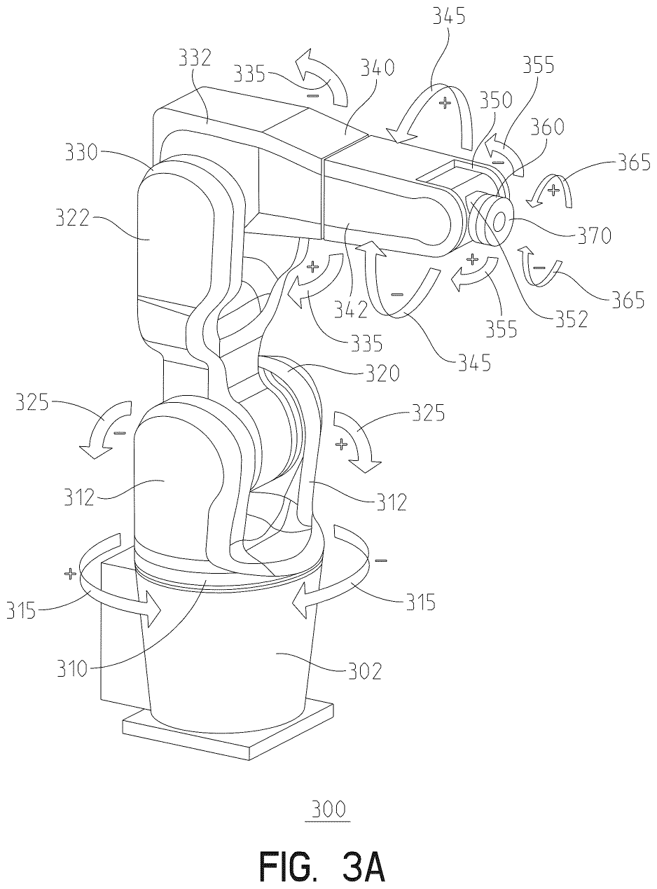

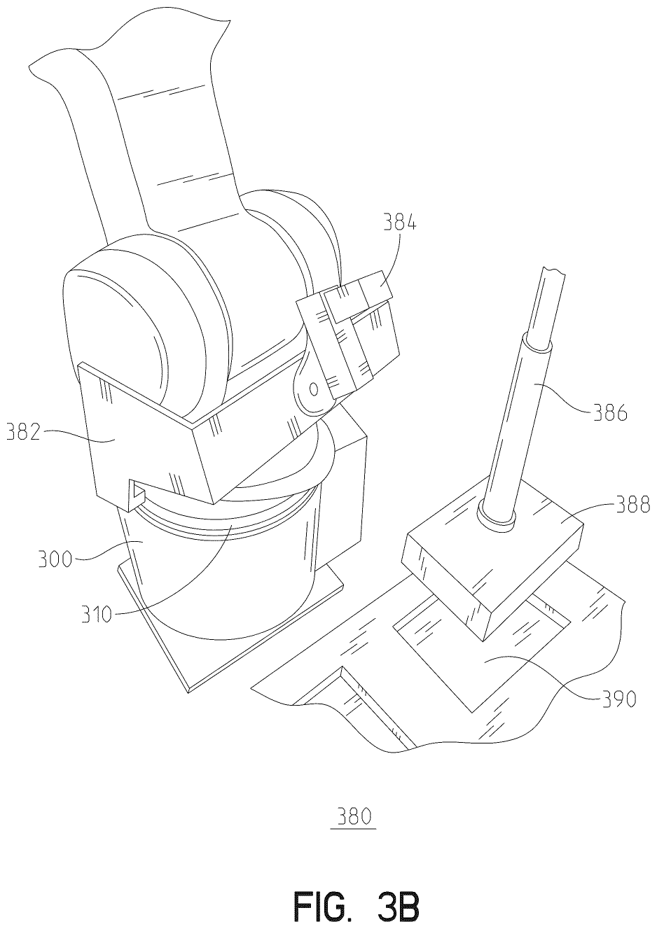

The robotic system implements a vision system and/or perception system (e.g., via an image capturing device) that moves with the robotic system to acquire information about the pose of the object (e.g., capturing images of the object) on the fly. For example, an image capturing device may be placed on a moving part of the robotic system (e.g., on Link 1 of a robotic arm in the robotic system) and is configured to move with the moving part of the robotic system. With this configuration, the image capturing device is enabled to collect pose information of the object that is decoupled from the motion of the moving part. Based on the information collected by the image capturing device, the robotic system may manipulate other parts of the robotic system (other joints in the robotic arm) to adjust the pose of the object according to the information provided by the image capturing device. Moreover, the robotic system may move the object along with the entire robot through the moving part and adjust the pose of the object through other parts of the robotic system in parallel. It should be noted that the moving part on which an image capturing device is placed may be associated with any joint in the robotic arm. In some variations, some or all of the joints in the robotic arm may have image capturing devices placed thereon. For instance, a second image capturing device may be placed on the link connecting to Joint 3 as shown in FIG. 3A to capture images while the robotic arm is moving in the vertical direction.

Conventional robotic systems estimate the pose of the object in the gripper of a robotic system after each manipulation. In some circumstances, conventional robotic systems may rely on image capturing devices deployed at specific locations in the environment, such as at pick-up locations or destinations. For example, a camera may be positioned next to a pick-up location and is configured to face upwards from the ground to monitor the robot picking up objects. In this setup, the robot needs to move the object to the camera to obtain sufficient information to perform pose estimation on the object picked up by the robot. Some robotic systems may be equipped with image capturing devices to move with the robotic systems. However, when using these image capturing devices for pose estimation, conventional robotic systems will alternately (i) fix the entire robot to capture images and estimate the pose of the object and (ii) drive the robot to change pose and/or move. The technique disclosed herein provides advantages over conventional robotic system integration strategies/algorithms by enabling robotic systems to perform concurrent operations of motion and adjustments, and in particular allowing the robotic systems to gather and process information independently of certain motion of the robotic systems.

In some instances, multiple image capturing devices, such as color cameras, depth cameras, or any suitable combinations, may be placed on a moving part of the robotic system (e.g., on the Link 1 of a robotic arm in the robotic system) and are configured to move with the moving part of the robotic system. The information collected by the multiple image capturing devices may be combined to estimate a pose of the object based on a relative coordinate system that moves with the moving part and is stationary with respect to the image capture devices.

In some variations, the robotic system may implement one or more computer vision algorithms, including model-based and/or machine-learning-based approaches, to estimate the pose of the object. The robotic system may rely on the estimated pose of the object to determine adjustments to the pose of the object. For instance, the robotic system may be trained to manipulate the object into a desired pose that is independent of the motion of the robotic system through a specific moving part (e.g., the joint mounted with an image capturing device) with respect to the image capturing device, allowing the robotic system to adjust the pose of the object from one workspace to another as the robotic system moves through the specific moving part.

In particular, exemplary aspects of the robotic systems and/or robots according to the present disclosure, are further elucidated below in connection with exemplary embodiments, as depicted in the figures. The exemplary embodiments illustrate some implementations of the present disclosure and are not intended to limit the scope of the present disclosure.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

Where possible, any terms expressed in the singular form herein are meant to also include the plural form and vice versa, unless explicitly stated otherwise. Also, as used herein, the term “a” and/or “an” shall mean “one or more” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on”.

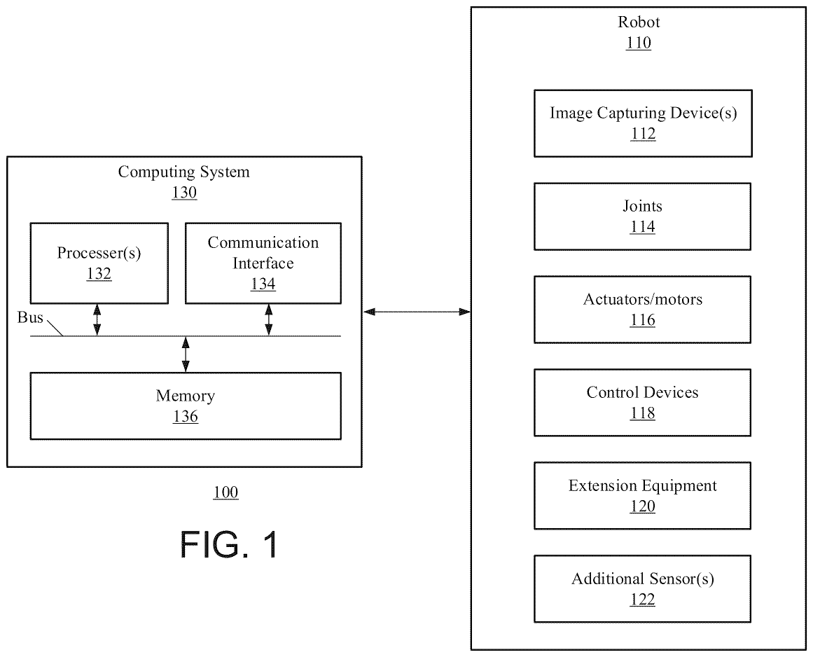

FIG. 1 illustrates a simplified block diagram depicting a robotic system 100 according to one or more examples of the present disclosure.

Referring to FIG. 1, the robotic system 100 includes a robot 110 and a computing system 130. The robot 110 includes various hardware and software components configured to perform specific tasks, such as perceiving the surroundings of the robot 110, engaging and/or disengaging an object, etc. The computing system 130 is configured to process data from the robot 110 and to generate signals/instructions based on the processed data. In some examples, the computing system 130 may be integrated in or communicatively coupled to control devices 118 in the robot 110. In some instances, the robotic system 100 may be communicatively connected to sensors (such as image capturing devices, depth sensors, etc.) set in the environment to obtain information about the environment in which the robotic system 100 is performing tasks. An object that interacts the robot 110 refers to an item or entity that comes into contact or engages with the robot 110 during a task or operation. An object may be any type of item, article, device, product, etc. that a robot 110 can maneuver from a first location to a second location. For example, FIG. 3B shows a box 388 as an example of the object.

The robot 110 includes one or more image capturing devices 112, a plurality of joints 114, a plurality of actuators/motors 116, and a control system 200.

The image capturing device(s) 112 is configured to capture images of an object being engaged by the robot 110. The image capturing device 112 may be a color camera, a depth camera, a combination thereof, or other suitable type of electronic image acquisition device. The image capturing device 112 may be located on and/or positioned on a joint 114 of the robot 110, such as on a link of a particular joint 114. The image capturing device(s) 112 can move with the particular joint 114 of the robot 110 to capture images on the fly. This is shown and described in FIG. 3B below.

The plurality of joints 114 are configured to enable motion of the robot 110 along different axes of movement. Each joint 114 is driven by one or more actuators/motors 116, allowing the robot 110 to move with a high degree of precision and flexibility. Actuators/motors 116 include AC motors, DC motors, gear-driven motors, linear motors, actuators, or any other electrically controllable device used to effect the kinematics of the robot 110.

The control devices 118 include one or more controllers and/or control units, through which the control devices 118 send signals/instructions to control operations of other components in the robot 110, such as to the plurality of actuators/motors 116 to control movement of the corresponding joints 114, or to the image capturing device(s) 112 and/or sensors to gather information, or to an end effector (e.g., an extension equipment 120) to interact with the environment (e.g., engaging/disengaging an object).

Additional sensors 122 may be located on and/or positioned at the robot 110, which may optionally be included within the control devices 118. These additional sensors 122 may provide information to the control devices 118 in conjunction with (or as a back-up to) information (e.g., images) provided by the image capturing device 112. For example, these additional sensors 122 may include a light sensor and/or flash camera sensor system that provides light/illumination for images captured using the image capturing device 112.

The robot 110 may optionally include an extension equipment 120, which may be a universal grasping tool attached to the robot 110 through a tool flange. The extension equipment 120 may be embodied as other types of end effector attached to the robot 110 through a mounting mechanism, such as a quick-change mechanism, a threaded coupling, or other suitable mounting mechanisms. In some instances, the extension equipment 120 may be integrated with the robot 110, while in other instances, the robot 110 may be separate from, but engageable to carry the extension equipment 120. In some variations, the extension equipment 120 may be electrically connected to the control devices 118 such that the control devices 118 send signals/instructions to control the operation of the extension equipment 120.

In some examples, the control devices 118 maneuver the robot 110 by changing the physical position and/or orientation of the joints 114 such that an object engaged by the robot 110 (e.g., via the extension equipment 120) becomes aligned for placement into a predefined location in a placement workspace. For instance, the control devices 118 may move a base joint of the robot 110 to move the object within a close proximity of the predefined location in the placement workspace and simultaneously move other joints to orient the object such that the object becomes aligned for placement into the predefined location in the placement workspace. In other instances, the control devices 118 may dynamically move the plurality of joints 114 in any order (including contemporaneously), providing for a smooth movement and placement of the object into the predefined location in a placement workspace with reduced cycle times.

Referring back to FIG. 1, the computing system 130 may be a part of or an extension of the control devices 118 of the robot 110. The computing system 130 includes one or more processors 132, a communication interface 134, a memory 136, which are communicatively coupled to a bus 138. Data can be transmitted between the one or more processors 132, the communication interface 134, and the memory 136 via the bus 138.

The one or more processors 132 are configured to perform operations in accordance with the instructions stored in the memory 136. The processor(s) 132 may be any appropriate type of general-purpose or special-purpose microprocessor (e.g., a CPU or GPU, respectively), digital signal processor, microcontroller, or the like.

The memory 136 is configured to store computer-readable instructions that, when executed by the processor(s) 132, can cause the processor(s) 132 to perform various operations disclosed herein. The memory 136 may be any non-transitory type of mass storage, such as volatile or non-volatile, magnetic, semiconductor-based, tape-based, optical, removable, non-removable, or other type of storage device or tangible computer-readable medium including, but not limited to, a read-only memory (“ROM”), a flash memory, a dynamic random-access memory (“RAM”), and/or a static RAM.

The communication interface 134 is configured to communicate information between the computing system 130 and the robot 110 as show in FIG. 1. As one example, the communication interface 134 may include an integrated services digital network (“ISDN”) card, a cable modem, a satellite modem, or a modem to provide a data communication connection. As another example, the communication interface 134 includes a local area network (“LAN”) card to provide a data communication connection to a compatible LAN. As a further example, the communication interface 134 may include a high-speed network adapter such as a fiber optic network adaptor, 10G Ethernet adaptor, or the like. Wireless links can also be implemented by the communication interface 134. In such an implementation, the communication interface 134 can send and receive electrical, electromagnetic or optical signals that carry digital data streams representing various types of information via a network. The network can typically include a cellular communication network, a Wireless Local Area Network (“WLAN”), a Wide Area Network (“WAN”), or the like. In some variations, the communication interface 134 may include various I/O devices such as a keyboard, a mouse, a touchpad, a touch screen, a microphone, a camera, a biosensor, etc.

In some examples, the computing system 130 may implement a machine learning (ML)/artificial intelligence (AI) training system that trains ML and/or AI models, datasets, and/or algorithms (e.g., neural networks (NN) and/or convolutional neural networks (CNNs)). The ML/AI model may be used by the robotic system 100 to help maneuver the robot 110 to perform specific tasks, possibly with reduced computational overhead. For example, the computing system 130 may train a ML/AI model or implement a trained ML/AL Model, and the ML/AI Model may be used to predict the next movement of the robot 110 to precisely place an object to a predefined location in a placement workspace.

In some instances, the computing system 130 may be implemented using one or more computing platforms, devices, servers, and/or apparatuses. In other instances, the computing system 130 may be implemented as engines, software functions, and/or applications. In other words, the functionalities of the computing system 130 may be implemented as software instructions stored in storage (e.g., memory) and executed by one or more processors.

In some variations, the robotic system 100 uses one or more images, or a continuous succession or series of images and/or videos, captured using the image capturing device(s) 112 to maneuver the robot 110 to perform specific tasks. For example, the robotic system 100 captures one or more images that includes the object engaged by the robot 110. The robotic system 100 uses the one or more images to maneuver the robot 110 to adjust the pose of the object so that the robot 110 can precisely place the object at the predefined location in the placement workspace. In some instances, the robotic system 100 may use a trained neural network to determine regions of interest and/or points of interest (e.g., key points) within the image. The robotic system 100 uses the determined regions of interest/key points to determine the pose of the object and/or the adjustment to the pose of the object. Based on the pose of the object and/or the adjustment to the pose of the object, the robotic system 100 maneuvers the robot 110 to adjust the pose of the object.

It will be appreciated that the exemplary robotic system 100 depicted in FIG. 1 is merely an example, and that the principles discussed herein may also be applicable to other situations—for example, other types of robots 110.

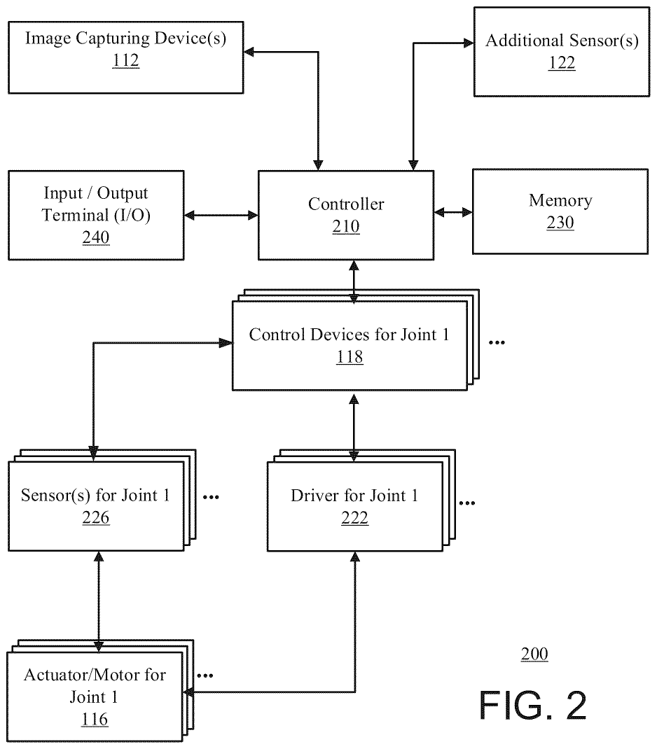

FIG. 2 is a schematic illustration of an exemplary control system 200 according to one or more embodiments of the present disclosure. The control system 200 includes control devices 118 and other suitable entities (e.g., the image capturing device 112, the computing system 130, etc.) from FIG. 1. It will be appreciated that the control system 200 shown in FIG. 2 is merely an example and additional/alternative embodiments of the control system 200 are contemplated within the scope of the present disclosure.

The control system 200 includes a controller 210. The controller 210 is not constrained to any particular hardware, and the controller's configuration may be implemented by any kind of programming (e.g., embedded Linux) or hardware design—or a combination of both. For instance, the controller 210 may be formed by a single processor, such as general purpose processor with the corresponding software implementing the described control operations. On the other hand, the controller 210 may be implemented by a specialized hardware, such as an ASIC (Application-Specific Integrated Circuit), an FPGA (Field-Programmable Gate Array), a DSP (Digital Signal Processor), a GPU (graphics processing unit), an NVIDIA Jetson Device, a hardware accelerator, a processor operating TENSORFLOW, TENSORFLOW LITE, PYTORCH, and/or other ML software, and/or other devices. In some instances, the control system 200 and/or the controller 210 may be an edge computing hardware that is on and/or included within the robot 110.

The controller 210 is in electrical communication with memory 230. The memory 230 may be and/or include a computer-usable or computer-readable medium such as, but not limited to, an electronic, magnetic, optical, electromagnetic, infrared, or semiconductor computer-readable medium. More specific examples (e.g., a non-exhaustive list) of the computer-readable medium may include the following: an electrical connection having one or more wires; a tangible medium such as a portable computer diskette, a hard disk, a time-dependent access memory (RAM), a ROM, an erasable programmable read-only memory (EPROM or Flash memory), a compact disc read-only memory (CD_ROM), or other tangible optical or magnetic storage device. The memory 230 may store corresponding software such as computer-readable instructions (code, script, etc.). The computer instructions being such that, when executed by the controller 210, cause the controller 210 to control the control system 200 to provide for the operation of the robot 110 as described herein.

The controller 210 is configured to provide and/or obtain information such as the one or more images from the image capturing device 112. For instance, the image capturing device 112 may capture one or more images, or a continuous succession of images, that include an object that is engaged by the robot 110, and may provide the images to the controller 210. The controller 210 may use these images (alone or in combination with other elements of the control system 200) to determine the pose and/or other suitable status of the object.

Additional sensors 122 may optionally be included within the control system 200. These additional sensors 122 may provide information to the control system 200 in conjunction with (or as a back-up to) information (e.g., images) provided by the image capturing device 112.

Additionally, and/or alternatively, the additional sensors 122 may optionally include another image capturing device (2D or 3D), a LiDAR sensor, a radio-frequency identification (RFID) sensor, an ultrasonic sensor, a capacitive sensor, an inductive sensor, a magnetic sensor, and/or the like, to refine the trajectory of the robot end-effector as it manipulates the object into a pre-defined pose after a visual identification of an initial pose of the object has been made using visual or video information as described herein. In general, any sensor that can provide a signal that enables or enhances the control system's 200 ability to maneuver the robot 110 for efficient and precise pick and/or placement of an object may be included in the control system 200.

In some variations, the image capturing device 112 and additional sensors 122 form a flash-based photography sensing system. The flash-based photography system includes at least an image capturing device (e.g., device 112) and a light emitter (e.g., used for emitting a flash). In operation, the light emitter cycles the flash, or provides a constant light by keeping the light emitter continuously illuminated and the resulting image is captured by the image capturing device 112.

The control system 200 is configured to drive actuators/motors 116 for the joints 114 of the robot 110. Each joint 114 may be driven by an actuator/motor 116. As used herein, actuators/motors 116 include AC motors, DC motors, gear-driven motors, linear motors, actuators, or any other electrically controllable device used to effect the kinematics of the robot 110. Accordingly, the control system 200 is configured to automatically and continually determine the physical state of the robot 110 and automatically control the various actuators/motors 116 of the joints 114 to maneuver the robot 110 to move the engaged object and/or adjust its pose.

The control system 200 includes control devices 118 (e.g., motor control units or MCUs) for the joints 114, e.g., as part of the controller 210 or separate devices. For a particular joint (e.g., Joint 1), control devices 118 control a driver 222 using feedback from one or more sensors 226 (e.g., encoders) in order to provide real-time control of the actuator/motor 116. Accordingly, the control devices 118 receive instructions for controlling the actuator/motor 116 (e.g., receives motor/actuator control signals from the controller 210), and interprets those instructions, in conjunction with feedback signals from the sensor(s) 226, to provide control signals to the driver 222 for accurate and real-time control of the actuator/motor 116 (e.g., sends motor/actuator driver signals). The driver 222 transforms the control signals, as communicated by the control devices 118, into drive signals for driving the actuator/motor 116 (e.g., sends individual operation signals to the motor/actuator). In another example, the control devices 118 is integrated with circuitry to directly control the actuator/motor 116.

The control devices 118 may be included as part of the controller 210 or a stand-alone processing system (e.g., a microprocessor). Accordingly, just like the controller 210, the control devices 118 are not constrained to any particular hardware, and the control devices'118 configuration may be implemented by any kind of programming or hardware design—or a combination of both.

The control system 200 may include an input/output (I/O) terminal 240 for sending and receiving various input and output signals. For example, the control system 200 may send/receive external communication or data to a user, a server (e.g., a billing server and/or an enterprise computing system), a power unit, etc. via the I/O terminal 240. The control system 200 may further control the user feedback interface via the I/O terminal 240 (or otherwise).

FIG. 3A demonstrates an exemplary robotic arm 300 according to one or more embodiments of the present disclosure. The robotic arm 300 may be embodied as or included in the robot 110 of the robot system 100 shown in FIG. 1. The robotic arm 300 may be controlled by the control system 200 shown in FIG. 2. It will be appreciated that the robotic arm 300 shown in FIG. 3A is merely an example and additional/alternative embodiments of the robotic arm 300 are contemplated within the scope of the present disclosure.

Referring to FIG. 3A, the robotic arm 300 has six joints and is referred to as a six-axis robot or articulated robot. In a six-axis robot, each joint has a specific range of motion and direction of movement. The joints of the robotic arm 300 are connected by rigid segments or sections, which are referred to as links. Links between adjacent joints may determine the overall reach and flexibility of the robotic arm 300. Links can vary in length, material, and shape depending on the specific application.

A first joint 310 (also referred to as Joint 1) is configured for base rotation. For instance, the first joint 310 allows the entire arm to rotate horizontally around a vertical axis (e.g., arrows 315 showing the rotation of Joint 1), thereby providing the robot with the ability to turn or swivel. Joint 1 may be connected to a base 302 (referred to as Link 0).

A second joint 320 (also referred to as Joint 2) is configured for shoulder rotation. The second joint 320 enables the upper arm to rotate vertically around a horizontal axis (e.g., arrows 325 showing the rotation of Joint 2), thereby allowing the arm to raise or lower. Joint 1 and Joint 2 may be connected by one or more links 312 (referred to as Link 1).

A third joint 330 (also referred to as Joint 3) is configured for elbow rotation. The third joint 330 permits the lower arm to rotate vertically around a horizontal axis (e.g., arrows 335 showing the rotation of Joint 3), thereby enabling the arm to bend or straighten. Joint 2 and Joint 3 may be connected by one or more links 322 (referred to as Link 2).

A fourth joint 340 (also referred to as Joint 4) is configured for wrist yaw. The fourth joint 340 allows the wrist to rotate vertically around a horizontal axis (e.g., arrows 345 showing the rotation of Joint 4), thereby enabling the arm to tilt or twist the end-effector. Joint 3 and Joint 4 may be connected by one or more links 332 (referred to as Link 3).

A fifth joint 350 (also referred to as Joint 5) is configured for wrist pitch. The fourth joint 350 allows the wrist to pivot around an axis that is rotatable with Joint 4 (e.g., arrows 355 showing the movement of Joint 5), controlling the pitch motion of the end-effector. Joint 4 and Joint 5 may be connected by one or more links 342 (referred to as Link 4).

A sixth joint 360 (also referred to as Joint 6) is configured for wrist roll. The sixth joint 360 enables the wrist to rotate vertically around a horizontal axis (e.g., arrows 365 showing the rotation of Joint 6), controlling the roll motion of the end-effector. Joint 5 and Joint 6 may be connected by one or more links 352 (referred to as Link 5).

The robot arm 330 may optionally include a tool flange 370 or a suitable type of mounting mechanism, which is configured to connect to an end-effector (e.g., an extension equipment 120). In some instances, the tool flange 370 may be integrated in or formed by one or more links (referred to as Link 6) between Joint 6 and an end-effector.

FIG. 3B shows an example of a robotic system 100 operating in a working environment 380 according to one or more embodiments of the present disclosure. The robot system includes a robotic arm 300 shown in FIG. 3A. The robotic system 100 may be controlled by the control system 200 shown in FIG. 2. It will be appreciated that the robotic system 100 shown in FIG. 3B is merely an example and additional/alternative embodiments of the robot 380 are contemplated within the scope of the present disclosure.

Referring to FIG. 3B, a first joint 310 of the robotic arm 300 is configured to move the entire robotic arm 300 to rotate horizontally around a vertical axis. A link 382 connects two opposite sides of the first joint 310. An image capturing device 384 is mounted on the link 382. As such, when the first joint 310 rotates, the image capturing device 384 moves with the entire robotic arm 300. The camera angle of the image capturing device 384 may be fixed or variable. Multiple image capturing devices 384 may be mounted on the link 382. In some variations, one or more image capturing devices 384 may be mounted on other joints in the robotic arm 300.

Further, the robotic arm 300 is connected to a suction device 386 through its mounting mechanism (not shown in FIG. 3B). The operation of the suction device 386 may be controlled by the control system 200 shown in FIG. 2. For example, the control system 200 may control the suction device 386 to grip an object (e.g., a box 388) by creating a vacuum seal with the object's surface. Once the suction device 386 has a secure grip, the control system 200 may control the robotic arm 300 to move the object to a desired location (e.g., an insertion slot 390). At the target location, the control system 200 may deactivate the suction device 386 to release the vacuum seal with the object's surface. In this way, the control system 200 may control the robotic system 100 to place the object at the target location.

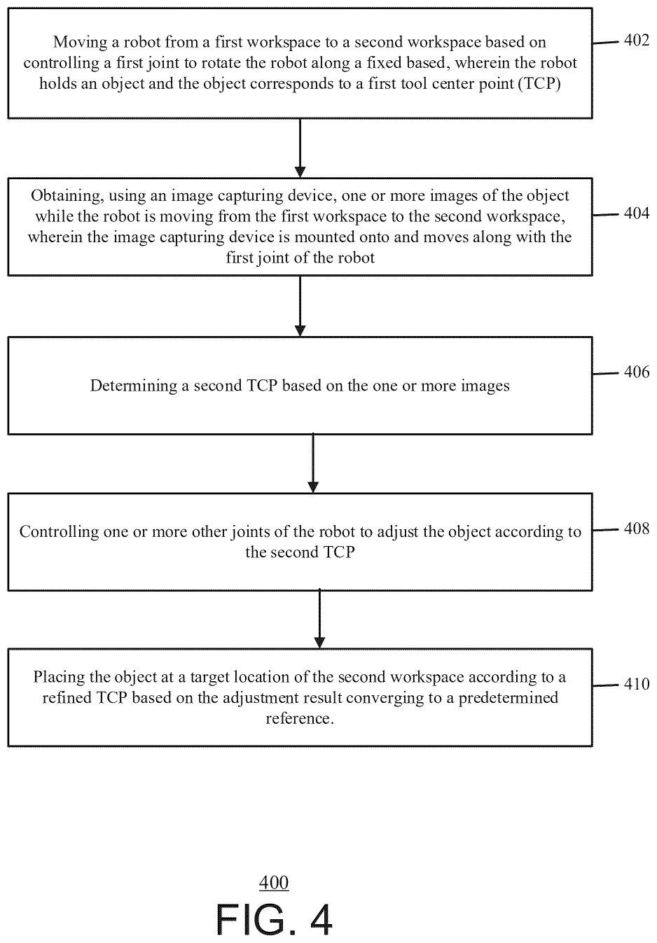

FIG. 4 illustrates a process 400 for operating a robotic system 100 according to one or more embodiments of the present disclosure. The process 400 may be performed by the control system 200 and in particular the control system 200 shown in FIG. 2. However, it will be recognized that any of the following blocks may be performed in any suitable order and that the process 400 may be performed in any suitable environment and by any suitable controller or processor.

The robot 110 in the robotic system 100 includes a plurality of joints. The plurality of joints include a first joint that rotates the entire robot 110 along a fixed base and one or more other joints.

At block 402, the control system 200 moves the robot 110 from a first workspace to a second workspace based on controlling a first joint (e.g., first joint 310) to rotate the robot 110 along a fixed base. The robot 110 holds an object and the object corresponds to a first tool center point (TCP). The first workspace may be a picking workspace from which the control system 200 moves the robot 110 to pick objects. The second workspace may be a placement workspace into which the control system 200 moves the robot 110 to place objects.

A TCP for a robot 110 may be a specific point on the end-effector (e.g., a suction device) of the robot 110, where actions, such as grasping, manipulating, or interacting with the object, are performed. TCP for a robot 110 indicates the location where the tool makes contact or interacts with the environment (e.g., objects). The TCP is a crucial reference point for programming and controlling the robot's 110 movements. The position and orientation of the TCP may determine how the robot 110 approaches, handles, and interacts with objects during tasks. The accuracy and control of the TCP are essential for ensuring precise movements and successful task execution. In some examples, the TCP may be defined and calibrated based on the design and geometry of the end-effector or tool attached to a robot arm. In some instances, the TCP may be determined according to a coordinate system established by selecting a base reference point (e.g., the base of the robot 110) and defining the three axes (X, Y, and Z) for position and orientation. The coordinate system may be relative or universal.

A TCP for a robot 110 with an object in the end-effector (e.g., a suction device) may be defined as a specific point on the object when a robot 110 comes into contact with the object, for example when the object is held by the robot 110 through a suction device. The object's TCP reflects the pose of the object when it is in contact with the robot 110 from the object's point of view. For instance, the TCP for a robot 110 with an object in the end-effector may be defined as the geometric center of the top/bottom surface of the object, while the TCP for the robot 110 without an object in the end-effector may be defined as the center point of the contact surface of the end-effector (e.g., a suction device) of the robot 110. When the robot 110 successfully picks the object, a proper TCP needs to be find according to the actual pose of the object in the end-effector, so that the object placing task can be correctly processed. To this end, the control system 200 may calculate an offset between the new robot's TCP and the robot's 110 TCP without object in the end-effector based on the pose information obtained for the object.

In some examples, the control system 200 may determine the robot's TCP with the object in its end-effector as the first TCP corresponding to the object. The control system 200 may determine the first TCP based on information (e.g., captured images) collected by image capturing devices 112 and/or other sensors in the robotic system 100. In some instances, the control system 200 may determine the first TCP based on the field of view of an image capturing device 112 mounted on the robot 110. The field of view of the image capturing device 112 may be associated with a relative coordinate system such that the image capturing device 112 may record changes in the object's pose in the relative coordinate system, thereby allowing the control system 200 to calculate offsets to update the TCP of the object.

In some variations, the control system 200 may obtain an initial TCP for the object placement manipulation when the robot 110 picks an object from the first workspace. The first workspace may be an environment equipped with a number of sensors (e.g., image capturing devices, distance sensors, etc.). The control system 200 may determine an initial TCP based on information collected by the number of sensors, or receive such information from a computing system in communication therewith. Alternatively, when the control system 200 controls the robot 110 to successfully pick up an object from the first workspace, the control system 200 may set a default TCP for the object placement manipulation.

At block 404, the control system 200 uses the image capturing device 112 to obtain one or more images of the object while the robot 110 is moving from the first workspace to the second workspace. The image capturing device 112 is mounted onto and moves along with the first joint of the robot 110. The one or more images may be individually photographed images or may be frames included in a video stream. In some variations, the one or more images may include color images, depth images, or a combination thereof.

The control system 200 controls the first joint to move the entire robot 110 along with the image capturing device 112. While moving the robot 110 along (e.g., in parallel), the control system 200 may also control the one or more other joints to adjust the pose of the object based on the one or more images captured by the image capturing device 112.

The captured image includes a multitude of pixels to capture the object, or a portion thereof, within a particular field of view. The control system 200 may control motion of the one or more other joints of the robot 110 to allow the image capturing device 112 to capture images of the object from different viewpoints. Furthermore, the control system 200 may process raw images from the image capturing device 112 to suppress background and/or noise information in the captured images. For example, the control system 200 may crop a captured image to remove background around the object. Additionally and/or alternatively, the control system 200 may combine multiple captured images so as to filter the background and/or noise in the captured images. For instance, different images may contain different background as the robot 110 is moving through the first joint. The control system 200 may identify the changing background from the combined image and then remove the background.

At block 406, the control system 200 determines a second TCP based on the one or more images.

The control system 200 may identify a pose (e.g., a position and/or orientation) of the object based on the captured image(s). In some examples, the control system 200 may implement a trained ML model (e.g., trained CNN) and input the captured images into the trained ML model to determine one or more regions of interest. The control system 200 may further use one or more image processing algorithms or techniques (e.g., scale-invariant feature transform (SIFT) technique) on the determined regions of interest to determine the pose of the object. In some examples, the ML model may be trained to take one or more captured/processed images (e.g., a color image, a depth image, or a combination thereof) as an input to output an estimated pose of the object. The pose of an object may be defined by six degrees of freedom (DOF), including displacement along the x, y, and z axes in a particular coordinate system, and rotation about the three axes (e.g., roll, pitch, and yaw).

The control system 200 may quantify the pose of the object according to a relative coordinate system corresponding to the field of view of the image capturing device 112. For instance, the pose of the image capturing device 112 relative to the coordinate system of the robotic system (e.g., according to the base of the robot 110) may be calibrated when the system is set up. In this way, the control system 200 can convert between the relative coordinate system corresponding to the image capturing device 112 and the coordinate system corresponding to the robot 110 according to the calibration results. In some variations, the control system 200 may describe the pose of the object based on a point of interest on the object (e.g., the geometric center at the bottom surface of the object) and other suitable parameters associated with shape or orientation.

The control system 200 may determine the second TCP based on the pose of the object. For example, the control system 200 may calculate an offset between the first TCP of the object and the pose of the object described in the relative coordinate system corresponding to the image capturing device 112, and then apply the offset to the first TCP of the object to obtain the second TCP of the object. Alternatively, control system 200 may extract suitable parameters (e.g., the geometric center of the object) based on the pose of the object described in the relative coordinate system corresponding to the image capturing device 112 and use the extracted parameters to determine the second TCP of the object.

At block 408, the control system 200 controls the one or more other joints of the robot 110 to adjust the object held by the robot 110 according to the second TCP.

Based on the second TCP of the object, the control system 200 may determine an adjustment to be performed by one or more other joints, such as moving, pitching, yawing, or rotating the object to a certain degree.

In some examples, the control system 200 may determine the adjustment based on a difference between the second TCP and a target TCP for the object. A target TCP may be a predefined TCP that indicates a desired pose of the object held by the robot 110 so that the robot 110 can achieve precise placement of the object. The precise placement robot target is defined based on the target TCP. When the image capturing device 112 is set to a fixed camera angle, the desired pose of the object may be reflected as a specific pose in the captured image.

The control system 200 may calculate an offset between the second TCP and the target TCP according to the relative coordinate system corresponding to the image capturing device 112. Based on the calculated offset, the control system 200 may determine an adjustment to be performed by the other joints and generate control signals/instructions to the other joints accordingly in order to reduce or even eliminate the offset.

In some instances, the control system 200 may compare the current pose of the object to a desired pose to determine the adjustment to be performed. As mentioned above, when the image capturing device 112 is set to a fixed (or a predetermined) camera angle, the desired pose of the object may be reflected as a specific pose in the captured image. During the calibration, the robot 110 may be configured to hold the object in the desired pose, while the control system 200 may control the image capturing device 112 to capture the desired pose from one or more predetermined camera angles. To this end, the control system 200 may store the image(s) corresponding to the desired pose of the object for later reference. Additionally and/or alternatively, the control system 200 may extract a set of parameters to represent the desired pose of the object and store the set of parameters for later reference.

The control system 200 may apply suitable vision detection algorithms (e.g., by applying a trained ML/AL model) to compare the current pose of the object to the desired pose to determine the adjustment to be performed by the other joints. After a number of iterations, the image capturing device 112 may “see” the object in the field of view exactly as it would be in the ideal picking position.

Based on the determined adjustment, the control system 200 may maneuver (e.g., move/orient) the other joints to adjust the pose of the object. Particularly, the control system 200 may send control signals, which may include instructions, to operate actuators/motors 116 to correctly move and position the other joints 114 to manipulate the pose of the object held by the robot 110. More particularly, the control system 200 determines control signals for actuators/motors 116, which are configured to (when executed) controllably operate the actuators/motors 116 to position and orient the object engaged by the robot 110 (e.g., through the extension equipment 120). The control system 200 then sends those control signals to execute the specified movements. The actuators/motors 116 may include a plurality of actuators/motors collectively configured to (ultimately) place the object to the target location in the second workspace. In some instances, the actuators may be specifically utilized for fine-tuning the orientation/position of the object, and the actuator control signals are directed at controlling such actuators.

The control devices 118 for a particular joint 114 receives the motor/actuator control signals, and may further receive feedback signals. The feedback signals are provided by sensor(s) 226 detecting the state/position of the various motors/actuators of the other joints in robot 110. Based on the feedback signals and the motor/actuator signals, the control devices 118 determines motor driver signals and actuator driver signals for the particular joint. As such, the control signals may be high-level instructions for the operation (or resulting position) of the elements of the robot 110, and the control devices 118 may interpret those high-level instructions (as informed by the feedback signals) to provide lower-level control signals for individually driving the motors/actuators. The control devices 118 sends the motor driver signals and actuator driver signals directly to the driver 222 for the particular joint. In some examples, the control devices 118 includes circuitry capable of operating the appropriate voltage and currents for driving actuators coupled to its processing system (e.g., a microcontroller, FPGA, ASIC, etc.), and therefore, may send the motor driver signals and actuator driver directly to the actuators/motors 116.

After the adjustment, the control system 200 may determine whether the adjustment result (e.g., the resulted TCP/pose of the object) converges to a predetermined reference.

In some examples, the control system 200 may obtain an estimated TCP indicative of the pose of the object after adjustment. The estimated TCP may be determined based on the second TCP and the motion of the other joints. Then, the control system 200 may determine whether the estimated TCP converges to the target TCP.

In some instances, the control system 200 may control the image capturing device 112 to capture one or more images of the object after the adjustment. By applying vision detection algorithms to the captured image(s), the control system 200 may determine whether the updated pose of the object converges to a predetermined reference. The control system 200 may compare the updated pose of the object in the captured images to desired pose shown in the prestored reference images. For instance, the control system 200 may implement a trained ML/AL model to determine whether key features in two input images match. Additionally and/or alternatively, the control system 200 may extract a set of parameters to represent the updated pose of the object and compare the extracted set of parameters to the prestored set of parameters corresponding to the desired pose.

When the control system 200 determines that the adjustment result (e.g., the resulted TCP/pose of the object) converges to the predetermined reference, the control system 200 may control the robotic system 100 to gather appropriate information to obtain a refined TCP of the object and then proceed to the next operation (e.g., at block 410). For instance, the control system 200 may use the calculated TCP after the adjustment as the refined TCP for the object. Optionally, the control system 200 may fine-tune the refined TCP based on additional images captured by the image capturing device 112. The control system 200 may further adjust the pose of the object through the other joints. In an example, the control system 200 may make adjustments to the object (e.g., through the other joints) and fine-tune the refined TCP until difference between two adjacent object pose estimation is less than one millimeter. When the control system 200 determines that the adjustment result does not converge to the predetermined reference, the control system 200 may perform operations in blocks 404-408 for a number of iterations until the adjustment result converges to the predetermined reference.

At block 410, the control system 200 places the object at the target location of the second workspace according to a refined TCP. In some examples, the control system 200 may determine a refined TCP of the robot 110 to perform the placement of the object. The refined TCP of the robot 110 may be related to the actual pose of the object in the end-effector by an offset that may be calculated based on the desire pose of the object in the end-effector.

When the control system 200 determines that the adjustment result converges to the predetermined reference, the control system 200 may terminate the loop of pose (or object's TCP) adjustment and proceed to obtain a refined TCP for the object or the robot 110.

The control system 200 determines that the first joint completes the movement from the first workspace to the second workspace and at the same time the refined TCP for the object is ready. Then, the control system 200 controls the robot 110 to place the object at the target location of the second workspace and release the object.

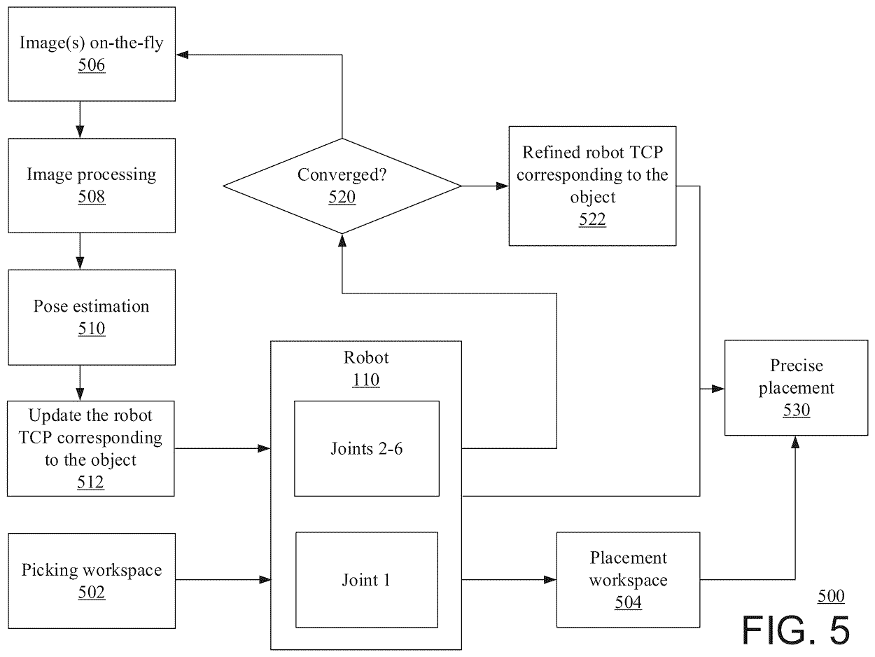

FIG. 5 is a flowchart demonstrating an example process 500 for operating a robotic system 100 according to one or more embodiments of the present disclosure. The process 500 may be performed by the control system 200 and in particular shown in FIG. 2. However, it will be recognized that any of the following blocks may be performed in any suitable order and that the process 500 may be performed in any suitable environment and by any suitable controller or processor.

Referring to FIG. 5, the robot 110 in the robotic system 100 includes a first joint (e.g., Joint 1) and five other joints (e.g., Joint 2-Joint 6). Joint 1 rotates the entire robot 110 along a fixed base, and an image capturing device 112 is mounted on Link 1 that connects Joint 1 and Joint 2.

The control system 200 controls Joint 1 and Joints 2-6 to perform parallel tasks. The control system 200 controls Joint 1 to move an object held by the robot 110 from a picking workspace 502 to a placement workspace 504, referring to block 402 in FIG. 4 for exemplary embodiments.

In the meantime, the control system 200 controls the image capturing device 112 to obtain on-the-fly images 506 of the object when Joint 1 rotates the entire robot 110 and controls Joints 2-6 to adjust the pose of the object based on the captured images. The control system 200 continuously updates a TCP for the object according to the pose of the object in the grip of the robot 110, which is obtained based on the captured on-the-fly images 506.

Particularly, the control system 200 performs image processing 508 on the captured images to enhance information about the object and/or suppress the background/noise information. The control system 200 may perform the image processing 508 in two steps. In a first step, the control system 200 may crop a captured image to remove the background around the object. The control system 200 may apply feature extraction techniques or other suitable image processing algorithms to achieve optimal cropping of captured images. Next, the control system 200 may combine multiple captured images so as to filter the background and/or noise in the captured images. For instance, different images may contain different background as the robot 110 is moving through the first joint. The control system 200 may identify the changing background from the combined image and then remove the background. These image processing operations may reduce image size and filter out background noise, thereby improving the quality and efficiency of the image processing.

Based on the processed images, the control system 200 performs pose estimation 510 for the object and updates the robot TCP corresponding to the object (in block 512) accordingly, referring to block 406 in FIG. 4 for exemplary embodiments. As an example, the control system 200 may implement computer vision algorithms to perform the pose estimation. For instance, a model may be trained to take one or more processed image as an input to output an estimated pose of the object. The pose of an object may be defined by six degrees of freedom (DOF), including displacement along the x, y, and z axes in a particular coordinate system, and rotation about the three axes (e.g., roll, pitch, and yaw). In block 512, the control system 200 may determine an updated TCP corresponding to the object based on the estimated pose of the object and use the updated TCP as the current TCP corresponding to the object.

Based on the updated TCP, the control system 200 generates control signals/instructions for Joints 2-6 to adjust the pose of the object, referring to block 408 in FIG. 4 for exemplary embodiments of controlling Joints 2-6 to adjust the object according to the updated TCP. The control system 200 may further update the TCP of the object according to the adjustment. In block 520, the control system 200 may compare the adjustment result to a predetermined reference to determine whether to perform another iteration of pose adjustment (e.g., through blocks 506, 508, 510, 512, Joints 2-6, and 520) or to terminate the loop. Process 400 in FIG. 4 (e.g., in blocks 408 and 410) provides exemplary embodiments of determining convergence based on a target TCP or a desired pose of the object. In block 522, when the control system 200 determines that the adjustment result converges to the predetermined reference, the control system 200 proceed to generate a refined robot TCP corresponding to the object for the final placement.

In block 530, when the control system 200 determines that the refined TCP of the object (in block 522) is ready and Joint 1 has completed the movement from the picking workspace 502 to the placement workspace 504, the control system 200 proceeds with performing the precise placement for the object, referring to block 410 in FIG. 4 for exemplary embodiments of placing the object based on the refined TCP.

In some examples, the robotic system 100 may train a ML/Al model to perform process 400 shown in FIG. 4 and/or process 500 shown in FIG. 5.

In the training stage, the robotic system 100 may start with an ideal picking point, an ideal TCP of the object, and/or an ideal placement point, which requires minimal, if any, adjustments to the object. The ideal values may be stored in the memory of the control system 200. In some instances, the object may be manually placed on the gripper of the object to ensure that the object is picked at the ideal picking point. Small errors (e.g., an offset to the ideal picking point) may be introduced to allow the robotic system 100 to learn to adjust the object.

During training of the robotic system 100, the control system 200 uses the image capturing device 112 to capture one or more images of the object that is picked at the ideal picking point. As such, the control system 200 knows where the ideal location of the object is and how it will look (e.g., how it will appear in the captured images). The control system 200 may compare the object's updated TCP to the target TCP (e.g., the ideal TCP) to determine convergence. Additionally and/or alternatively, the control system 200 may compare the object's updated pose to an ideal pose (e.g., the desired pose of the object) to determine the convergence. For instance, the control system 200 may apply vision detection algorithms to determine how well the updated pose capture by the image capturing device 112 matches the ideal pose captured in an ideal image. An ideal image refers to an image of the object in the desired pose, which is captured by the image capturing device 112 at a predetermined viewpoint. Then, based on the updated TCP/pose corresponding to the object, the control system 200 may learn to control the robot 110 to place the object at the ideal placement point (e.g., the insertion slot 390 shown in FIG. 3B). The control system 200 may learn from the difference between the ideal placement point and the actual placement point to update learnable parameters in the ML/AL model, where suitable loss functions may be used.

While embodiments of the invention have been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. For example, the various embodiments of the kinematic, control, electrical, mounting, and user interface subsystems can be used interchangeably without departing from the scope of the invention. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. A method for controlling a robot comprising a plurality of joints, wherein the plurality of joints comprise a first joint that rotates the entire robot along a fixed base and one or more other joints, comprising:
moving the robot from a first workspace to a second workspace based on controlling the first joint to rotate the robot along the fixed base, wherein the robot holds an object and the object corresponds to a first tool center point (TCP);
obtaining, using an image capturing device, one or more images of the object while the robot is moving from the first workspace to the second workspace, wherein the image capturing device is mounted onto a link connected to the first joint and moves along with the first joint of the robot;
determining a second TCP based on the one or more images;
controlling the one or more other joints of the robot to adjust the object held by the robot according to the second TCP; and
placing the object at a target location of the second workspace according to a refined TCP based on the adjustment result converging to a predetermined reference.

2. The method according to claim 1, further comprising:
determining that the adjustment result does not converge to the predetermined reference;
obtaining, using the imaging device, one or more other images of the object while the robot is moving from the first workspace to the second workspace;
determining a third TCP based on the one or more other images;
controlling the one or more other joints of the robot to adjust the object held by the robot according to the third TCP; and
placing the object at the target location of the second workspace according to a refined TCP after the new adjustment result converging to the predetermined reference.

3. The method according to claim 1, wherein placing the object at the target location of the second workspace according to the refined TCP based on the adjustment result converging to the predetermined reference further comprises:
determining that the adjustment result converges to the predetermined reference;
determining a third TCP of the object based on the second TCP and the adjustment to the object;
obtaining, using the image capturing device, one or more images of the object after the adjustment; and
generating the refined TCP of the object based on the third TCP and the one or more images captured after the adjustment.

4. The method according to claim 1, further comprising:
processing the one or more images to obtain a viewpoint image; and
performing a pose estimation based on the viewpoint image,
wherein determining the second TCP based on the one or more images is based on the pose estimation.

5. The method according to claim 4, wherein processing the one or more images to obtain the viewpoint image further comprises:
cropping the one or more images based on the object captured in the one or more images; and
removing background in the cropped one or more images based on the one or more images acquired by the imaging device.

6. The method according to claim 1, wherein obtaining, using the image capturing device, one or more images of the object while the robot is moving from the first workspace to the second workspace further comprises:
controlling motion of the one or more other joints of the robot to allow the image capturing device to capture images of the object from different viewpoints.

7. The method according to claim 1, wherein the first TCP is associated with a relative coordinate system established based on a field of view of the image capturing device.

8. The method according to claim 7, wherein the adjustment result comprises an updated TCP of the object, wherein the predetermined reference comprises a target TCP of the object, wherein the target TCP of the object corresponds to a predetermined point on the object and is defined by coordinates in the relative coordinate system corresponding to the image capturing device, and wherein the adjustment result converging to the predetermined reference is based on the updated TCP of the object converging to the target TCP of the object.

9. The method according to claim 7, wherein the adjustment result comprises an updated pose of the object, wherein the predetermined reference comprises a desired pose of the object, and wherein the adjustment result converging to the predetermined reference is based on the updated pose of the object converging to the desired pose of the object.

10. The method according to claim 9, wherein the convergence between the updated pose of the object and the desired pose of the object is determined based on an image containing the updated pose of the object and an image containing the desired pose of the object.

11. The method according to claim 7, wherein determining the second TCP based on the one or more images further comprises:
determining a pose of the object in the relative coordinate system based on the one or more images;
determining an offset between the first TCP and the pose of the object in the relative coordinate system; and
determining the second TCP based on the first TCP and the offset.

12. The method according to claim 7, wherein determining the second TCP based on the one or more images further comprises:
determining a pose of the object in the relative coordinate system based on the one or more images;
obtaining one or more parameters of the object associated with a position and orientation of the object in the relative coordinate system; and
determining the second TCP based on the one or more parameters of the object.

13. The method according to claim 1, wherein the one or more images obtained by the image capturing device record motion of the object caused by the one or more other joints, the recorded motion of the object is independent of the motion of the first joint.

14. The method according to claim 1, wherein (i) operation of the first joint and (ii) operation of the image capturing device and the one or more other joints are controlled in parallel.

15. A robotic system, comprises:
a robot comprising a plurality of joints, wherein the plurality of joints comprise a first joint that rotates the entire robot along a fixed base and one or more other joints;
an image capturing device mounted onto a link connected to the first joint, wherein the image capturing device is configured to move along with the first joint of the robot and obtain one or more images of an object held by the robot; and
a control system configured to:
move the robot from a first workspace to a second workspace based on controlling the first joint to rotate the robot along the fixed base, wherein the robot holds the object and the object corresponds to a first tool center point (TCP);
obtain, using the image capturing device, one or more images of the object while the robot is moving from the first workspace to the second workspace;
determine a second TCP based on the one or more images;
control the one or more other joints of the robot to adjust the object held by the robot according to the second TCP; and
control the robot to place the object at a target location of the second workspace according to a refined TCP based on the adjustment result converging to a predetermined reference.

16. The robotic system according to claim 15, wherein the control system is further configured to:
determine that the adjustment result does not converge to the predetermined reference;
obtain, using the imaging device, one or more other images of the object while the robot is moving from the first workspace to the second workspace;
determine a third TCP based on the one or more other images;
control the one or more other joints of the robot to adjust the object held by the robot according to the third TCP; and
control the robot to place the object at the target location of the second workspace according to a refined TCP after the new adjustment result converging to the predetermined reference.

17. The robotic system according to claim 16, wherein the control system is further configured to:
determine that the adjustment result converges to the predetermined reference;
determine a third TCP of the object based on the second TCP and the adjustment to the object;
obtain, using the image capturing device, one or more images of the object after the adjustment; and
generate the refined TCP of the object based on the third TCP and the one or more images captured after the adjustment.

18. The robotic system according to claim 15, wherein the control system is further configured to:
process the one or more images to obtain a viewpoint image; and
perform a pose estimation based on the viewpoint image;
wherein the control system is configured to determine the second TCP based on the pose estimation.

19. The robotic system according to claim 15, wherein the one or more images obtained by the image capturing device record motion of the object caused by the one or more other joints, the recorded motion of the object is independent of the motion of the first joint.

20. The robotic system according to claim 15, wherein the control device is further configured to control (i) operation of the first joint and (ii) operation of the image capturing device and the one or more other joints in parallel.
